(19) United States
(12) Patent Application Publication
(10) Pub. No.: US 2008/0048551 A1
(43) Pub. Date: Feb. 28, 2008

(54) Image display device

(76) Inventors: Yuuichi Kijima, Chosei (JP); Shoji Shirai, Mobara (JP); Yoshiyuki Kaneko, Hachioji (JP); Nobuhiko Hosotani, Mobara (JP); Hiroshi Ito, Mobara (JP); Hiroyuki Tachihara, Ooamishirasato (JP); Shunichi Asakura, Sakae (JP)

Correspondence Address: MILBANK, TWEED, HADLEY & MCCLOY, 1 CHASE MANHATTAN PLAZA, NEW YORK, NY, 10005-1413, US

(21) Appl. No.: 11/890,853

(22) Filed: Aug. 8, 2007

(30) Foreign Application Priority Data
Aug. 9, 2006 (JP) 2006-216807
Sep. 15, 2006 (JP) 2006-250385

(51) Int. Cl. H01J 1/62

(52) U.S. Cl. 313/495

(57) ABSTRACT

The discharge between the electron source and the anode is prevented, thus providing a highly reliable image display device.

The data signal lines d and the scanning signal lines formed via an insulating layer INS are provided on the inside surface of the rear substrate SUB1, and further the electron sources ELS are formed at intersections between the data signal lines d and the scanning signal lines s. Discharge preventing members SSB are disposed on the scanning signal lines s. The discharge preventing members SSB have conductive layers ECL on an upper surface of an insulating core member MBD made preferably of glass, and is fixed in a lower surface thereof to the scanning signal lines s with an adhesive FGL such as frit glass. The width of the discharge preventing member SSB is arranged to be greater than the width of the scanning signal line s, and the dimensions are arranged so that the discharge preventing member SSB covers the scanning signal line s when viewed from the anode.

### BACKGROUND OF THE INVENTION

1. Field of the Invention

The present invention relates to a flat panel image display device using electron emission into a vacuum formed between a front panel and a rear panel, and is particularly suitable for suppressing variation in luminance in an image display device with a plurality of distance maintaining members provided between the both panels.

2. Related Art

As image display devices (display devices) superior in high-luminance and high-definition properties, color cathode-ray tubes have widely been used in the past. However, in accordance with recent improvements in picture quality of information processing devices and television broadcasting services, the demand for lightweight flat panel image display devices (flat panel displays, FPD for short) having high-luminance and high-definition properties, and requiring as little space as possible has been increasing.

As typical examples thereof, liquid crystal display devices, plasma display devices, and so on have come into practical use. Further, as devices particularly suitable for achieving high-luminance property, practical applications of various flat panel image display devices such as light emitting display devices using electron emission from electron sources to vacuums or organic EL displays characterized by the low power consumption have been achieved.

Among the FPD, a configuration of disposing the electron sources in a matrix is known in the field of the light emitting FPD. As one of such FPD, there can be cited electron emission image display devices using microscopic thin film cold cathode, which can be integrated.

Further, in the light emitting FPD, as the cold cathode there is used electron source such as a Spindt type, a surface conduction type, a carbon nanotube type, a metal-insulator-metal (MIM) type formed by stacking metal-insulator-metal layers, a metal-insulator-semiconductor (MIS) type formed by stacking metal-insulator-semiconductor layers, or a metal-insulator-semiconductor-metal type.

Image display panels of the flat panel image display devices are each composed of a rear panel provided with the electron source as described above, a front panel provided with a fluorescent layer and an anode forming an acceleration electrode for causing incident impacts of the electrons emitted from the electron source to the fluorescent layer, and a seal frame for sealing an inside space between the both panels facing each other in a predetermined reduced pressure condition. The image display devices are each composed by combining a drive circuit and so on with the image display panel.

Such image display devices as described above are each provided with the rear panel composed of a rear substrate having a number of data signal lines extending in a first direction and disposed in parallel to each other in a second direction traversing the first direction, an insulating film formed covering the data signal lines, a number of scanning signal lines extending in the second direction and disposed on the insulating film in parallel to each other in the first direction, and the electron sources disposed around the intersections between the data signal lines and the scanning signal lines. The rear substrate is an insulating plate preferably made of glass, and the signal lines described above are formed on the substrate.

In the present configuration, a scanning signal is applied to the scanning signal lines sequentially in the first direction (line sequential scanning). Further, the electron source described above is disposed at each intersection between the scanning signal lines and the data signal lines on the rear substrate. The both signal lines and the electron source are connected to each other directly or via a feed electrode, thus supplying the electron source with an electric current. Facing the rear panel composed of the rear substrate, there is provided the front panel composed of the front substrate having the fluorescent layer of a plurality of colors and the anode electrode (the positive electrode) disposed inside surface thereof facing the rear panel. At least the front substrate is formed of a light transmissive material such as glass, preferably. Then, the both panels are bonded with each other via the seal frame disposed on the peripheries of the inside surfaces of the both panels to seal the inside space formed by the rear panel, the front panel, and the seal frame, and the pressure of the inside space is reduced, thus the image display device is configured.

The electron sources are disposed at the intersections between the data signal lines and the scanning signal lines or in the vicinities thereof, and the amount of electrons (including switching on/off the emission) emitted from the electron source (cathode) is controlled in accordance with the amount of the current supplied to the data signal line or the electric potential difference between the data signal line and the scanning signal line. The electron emitted therefrom is accelerated by the high-voltage applied to the positive electrode (the anode) provided to the front substrate, and makes the incident impact to the fluorescent layer provided likewise to the front substrate to excite the fluorescent layer, thus the light with a color corresponding to the luminescence property of the fluorescent layer is emitted.

Each of the cathodes forms a pair with the corresponding part of the fluorescent layer to compose a unit pixel. In general, the unit pixels of three colors, red (R), green (G), and blue (B) form one pixel (a color pixel). It should be noted that in the color pixel, the unit pixel forming each of the colors is also called subpixel. The fluorescent layer of each of the unit pixels is provided so as to fill the opening (BM opening) provided to a light blocking film (a black matrix, BM for short) for improving the contrast, and emits with a predetermined amount of light when the electron flux (the electron beam) emitted from the cathode and accelerated by the anode makes the incident impact so as to sufficiently cover the fluorescent layer filling the opening of the black matrix.

In such a flat panel image display device, in general, a plurality of distance maintaining members (spacers) is fixedly disposed in the space surrounded by the support member between the rear and front panels, and maintains the distance between the both substrates to a predetermined distance in cooperation with the seal frame. The spacers are generally formed of high-resistivity plate-like members made of an insulating material such as glass or ceramics, and are usually disposed for a plurality of pixels at positions where the spacers do not interfere the operations of the pixels.

Further, the seal frame is fixed to the rear and front panels in the inside peripheries thereof with a sealing material such as frit glass, and airtight sealing is formed with the fixing section. The degree of vacuum of the depressurized space inside the display area formed of the both panels and the seal frame is, for example, 10⁻³ through 10⁻⁶ Pa.

Scanning signal line extraction terminals connected to the scanning signal lines provided to the rear substrate and the data signal line extraction terminals connected to the data signal lines are disposed through the sealing area between the frame member and the both substrates.

Further, in Japanese Patent No. 3554312, there is proposed an electron beam device having the spacer electrically and mechanically fixed using conductive glass frit when the spacer abuts on the electron source and an electrode in the flat panel image display device. The spacer is fixedly bonded by simply performing a heating process after applying the conductive glass frit. In addition, as documents disclosing the related art regarding the spacer, JP-A-10-144203 and JP-A-2000-251785 can be cited.

Regarding the light emitting image display device as described above, JP-A-2002-75254 discloses the configuration in which electrodes are disposed on abutting surfaces of the frame member where the frame member abuts on the both substrates, and a high-resistivity film is disposed on a side surface of a side wall abutting on the abutting surfaces. Further, JP-A-2002-100313 discloses a configuration of sequentially disposing two kinds of resistive films having different resistances from each other outside the display area for preventing discharge.

### SUMMARY OF THE INVENTION

To the anode disposed on the inside surface of the substrate forming the front panel, a high voltage of about 2 through 10 kV is applied with respect to the electric potential of the electron source disposed on the substrate of the rear panel. The distance between the electron source and the anode is in a range of 2 mm through 5 mm. Therefore, deterioration in insulation property of the surface of the member inside the depressurized space and electrostatic charge inside the depressurized space might cause discharge between the electron source and the anode. If the discharge occurs, the electron source is broken, and does not function as the display device, thus degrading the reliability of the display device.

In the image display device of this kind, measures against the discharge described above are indispensable. However, in the past, the measures might cause pollution and damages of the inside surface of the both substrates including the display area, which involves occurrence of problems incurring degradation of the display quality and posing problems for achieving longer operation life.

An object of the present invention is to prevent discharge between the electron source and the anode to provide a highly reliable image display device.

Another object of the present invention is to solve the problem described above, and to provide a long-lived image display device superior in display quality.

An image display device according to the present invention includes a plurality of scanning signal lines, a plurality of data signal lines traversing the scanning signal lines, a rear panel composed mainly of a rear substrate having a plurality of electron sources arranged adjacent to intersections between the scanning signal lines and the data signal lines inside a display area on an inside surface of the rear substrate, a front panel composed mainly of a front substrate having a plurality of fluorescent layers arranged corresponding to the electron sources and an anode, to which a high voltage is applied with respect to the electron sources, on the inside surface of the front substrate, and a plurality of distance maintaining members disposed between the front panel and the rear panel, a space between the front panel and the rear panel being sealed airtight.

Further, in order for achieving the object described above, the present invention includes at least one discharge preventing member disposed on the scanning signal line for suppressing discharge between the anode and the electron source. The discharge preventing member has a strip shape along the scanning signal line. The width of the strip-shaped discharge preventing member is preferably greater than the width of the scanning signal line.

Further, in the present invention, it is possible that the discharge preventing member is disposed on each of the scanning signal lines, a conductive layer is provided on the surface of each of the strip-shaped discharge preventing members facing the anode, and by applying the potential more positive than the potential of the electron source to a pair of conductive layers locating across the electron source, a convergence electrode for collecting the electrons emitted towards the anode using the quadrupole operation is formed.

Further, in the present invention, it is possible that the distance maintaining member is formed as a member having an inverted T-shaped cross-section composed of a strip section and a wall-like section, and the width of the strip section is made larger than the width of the scanning signal line. Further, it is also possible to provide a configuration in which conductive layers are provided on the surface of the strip section facing the anode and the surface of the wall-like section, and to set the surface resistance value of the conductive layer of the strip section lower than the surface resistance value of the conductive layer of the surface of the wall-like section.

Further, in the present invention, it is possible to dispose the discharge preventing member straddling the two scanning signal lines adjacent to each other.

In order for achieving the object described above, the present invention includes a protective electrode disposed adjacent to an inside surface of the frame member via an insulating layer covering a part of the scanning signal lines and the data signal lines provided on the rear substrate and kept at a potential lower than a potential of the acceleration electrode.

Further, the present invention further includes a high-resistivity film extending to cover an edge of the fluorescent film along the frame member and disposed at a predetermined distance from the frame member.

Still further, the present invention includes the second high-resistivity film inside surface of the frame member in addition to the high-resistivity film contiguous with the fluorescent film.

According to the configuration of the present invention, even if the discharge is caused inside the depressurized space, the discharge current can be discharged outside the depressurized space through the discharge preventing member, thus the breakage of the electron source can be prevented. Further, by using the conductive layers provided on the anode side of the discharge preventing member as the convergence electrode, improvement of the margin for preventing landing a different color area of the electron on the fluorescent material can be achieved.

By adopting a configuration of disposing the protective electrode in the vicinity of the inside surface of the frame member via an insulating layer covering a part of the scanning and data signal lines, and keeping the protective electrode at a potential lower than the potential of the acceleration electrode, the signal lines on the rear substrate and so on can be protected from the frame member inside surface creeping discharge, thus a long-lived image display device superior in display quality can be realized.

Further, since the high-resistivity film is further disposed so as to cover the edge of the fluorescent film, the concentration of the electric field at the edge of the part of the fluorescent surface where a high voltage is applied can be relaxed by the high-resistivity film functioning as a high voltage relaxation layer, thus occurrence of the discharge can be suppressed, and in cooperation with the effect of the protective electrode, a long-lived image display device superior in display quality can be realized.

Further, since the second high-resistivity film is disposed on the inside surface of the frame member, occurrence of the discharge can further be suppressed, thus the long-lived image display device superior in display quality can be realized.

### BRIEF DESCRIPTION OF THE DRAWINGS

FIG. 1 is a schematic diagram for explaining the overall configuration of the image display device according to the present invention.

FIG. 2 is a cross-sectional view of a substantial part of a rear panel for explaining a first embodiment of the present invention.

FIG. 3 is a cross-sectional view for explaining a modified example of a discharge preventing member SSB explained in FIG. 2.

FIG. 4 is a cross-sectional view for explaining another modified example of the discharge preventing member SSB explained in FIG. 2.

FIGS. 5A and 5B are an overall view of the rear panel for explaining the first embodiment of the present invention.

FIG. 6 is a cross-sectional view of the rear panel for explaining the configuration in the case in which the discharge preventing member is used for pixel separation.

FIG. 7 is a plan view of a substantial part for explaining the case in which the discharge preventing member is disposed straddling two scanning signal lines adjacent to each other.

FIG. 8 is a cross-sectional view of the substantial part shown in FIG. 7 in which the discharge preventing member is disposed straddling the two scanning signal lines adjacent to each other.

FIG. 9 is a cross-sectional view of a substantial part of a rear panel for explaining a second embodiment of the present invention.

FIG. 10 is a plan view of a substantial part for explaining the case in which a distance maintaining member provided with a discharge preventing function shown in FIG. 9 is disposed straddling the two scanning signal lines adjacent to each other.

FIG. 11 is a cross-sectional view of a substantial part shown in FIG. 10.

FIGS. 12A and 12B are diagrams for explaining an example of dimensions of the distance maintaining member provided with the discharge preventing function and having an inverted T-shaped cross-section.

FIG. 13 is a cross-sectional view of a substantial part of a rear panel for explaining a third embodiment of the present invention.

FIG. 14 is a schematic plan view of the rear panel shown in FIG. 13.

FIGS. 15A, 15B, and 15C are diagrams for explaining advantages of the image display device having a configuration without convergence electrodes.

FIGS. 16A, 16B, and 16C are diagrams for explaining advantages of the image display device having the configuration of the third embodiment of the present invention provided with the convergence electrodes.

FIGS. 17A and 17B are schematic views for explaining a fourth embodiment of the image display device according to the present invention, wherein FIG. 17A is a plan view viewed from the side of the front substrate, and FIG. 17B is a side view of FIG. 17A.

FIG. 18 is a schematic plan view along the A-A line shown in FIG. 17B.

FIG. 19 is a schematic cross-sectional view along the B-B line shown in FIG. 17A.

FIG. 20 is a schematic cross-sectional view along the C-C line shown in FIG. 18.

FIG. 21 is a schematic cross-sectional view for explaining a fifth embodiment of the image display device according to the present invention, and corresponding to FIG. 20.

FIG. 22 is a schematic cross-sectional view for explaining a sixth embodiment of the image display device according to the present invention.

FIG. 23 is a schematic cross-sectional view for explaining a seventh embodiment of the image display device according to the present invention, and corresponding to FIG. 22.

### DESCRIPTION OF THE PREFERRED EMBODIMENTS

The best mode of the present invention will hereinafter be described in detail with reference to the accompanying drawings of embodiments.

### First Embodiment

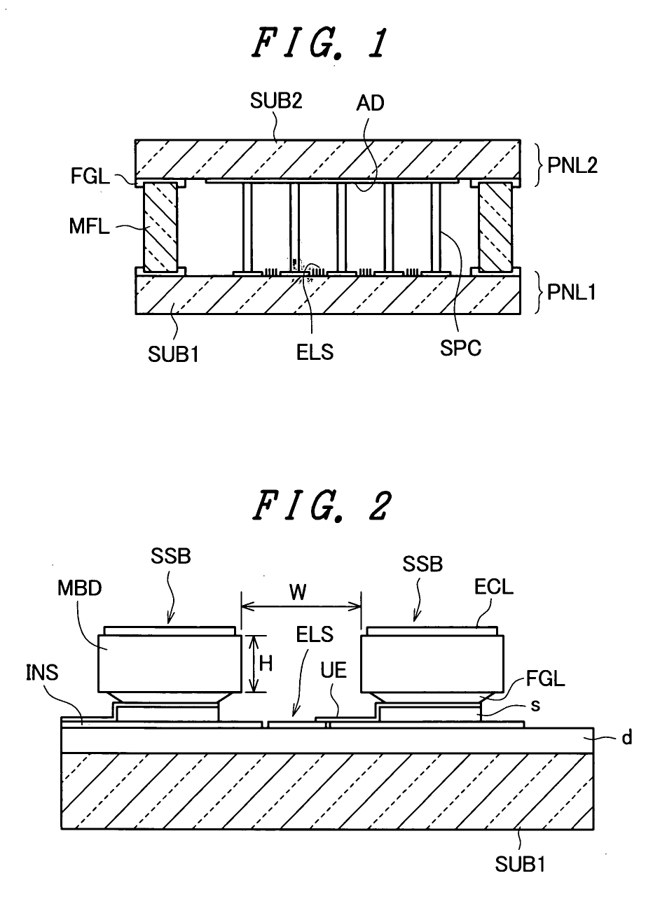

FIG. 1 is a schematic diagram for explaining the overall configuration of the image display device according to the present invention. The image display device is formed by disposing a rear panel PNL1 and a front panel PNL2 so that the principal surfaces thereof face each other, and integrally bonding them via a sealing frame MFL made preferably of glass with frit glass FGL. It should be noted that the both of the rear and front panels PNL1, PNL2 are also made preferably of glass. The inside surface of a rear substrate SUB1 forming the rear panel PNL1 is provided with a plurality of scanning signal lines, a plurality of data signal lines traversing the scanning signal lines, and a plurality of electron sources ELS disposed adjacent to intersections between the scanning signal lines and the data signal lines inside the display area. As the electron source ELS, there are cited a thin film electron source represented by the MIM type, a field emission electron source represented by a carbon nanotube (CNT), and so on.

The inside surface of a front substrate SUB2 forming the front panel PNL2 is provided with fluorescent layers (not shown) of a plurality of colors (generally R, G, and B) arranged corresponding to the electron sources ELS, and an anode AD inside the surface. The fluorescent layers fill openings of a light blocking film (a black matrix, not shown).

Between the rear panel PNL1 and the front panel PNL2, there is a plurality of distance maintaining members (spacers) SPC shaped like thin plates, and disposed inside the display area for regulating the distance (a cell gap) between the both panels, and the both panels are integrated by sealing the space between the both panels airtight with a seal frame MFL intervening between the peripheries of the both panels.

The spacers SPC are disposed so as to bridge between the scanning signal lines s on the rear panel PNL1 and the black matrix (on the anode AD) on the front panel PNL2, and are fixed with a conductive adhesive. It should be noted that in FIG. 1, illustration of the composing members such as the data signal lines are omitted.

FIG. 2 is a cross-sectional view of a substantial part of a rear panel for explaining a first embodiment of the present invention. The rear panel is provided with the data signal lines d formed on the inside surface (a principal surface) of the rear substrate SUB1, the scanning signal lines s formed thereon via an insulating layer INS, and further the electron sources ELS formed at intersections between the data signal lines d and the scanning signal lines s. In the case in which the electron sources ELS are the thin film electron emission sources, the electron sources ELS and the scanning signal lines are connected with connection electrodes UE and upper electrodes (not shown) formed on the connection electrodes UE.

In the first embodiment, discharge preventing members SSB are formed above the scanning signal lines s. The discharge preventing members SSB have conductive layers ECL on an upper surface (the surface facing the anode) of an insulating core member MBD made preferably of glass, and is fixed in a lower surface thereof to the scanning signal lines s with an adhesive FGL such as frit glass. It is preferable that the width of the discharge preventing member SSB is arranged to be greater than the width of the scanning signal line s, and the dimensions are arranged so that the discharge preventing member SSB covers the scanning signal lines when viewed from the anode. Regarding the relationship between the distance W between the adjacent discharge preventing members SSB and the thickness H of the insulating core member MBD, although the greater the thickness H is, the more the discharge preventing effect is obtained, H>3 W is preferable on an experimental basis.

By disposing the discharge preventing members SSB on every some scanning signal lines s or on every scanning signal lines s, if possible, even if the discharge is caused inside the depressurized space, the discharge current can be emitted outside the depressurized space via the discharge preventing member, thus the breakage of the electron source can be prevented.

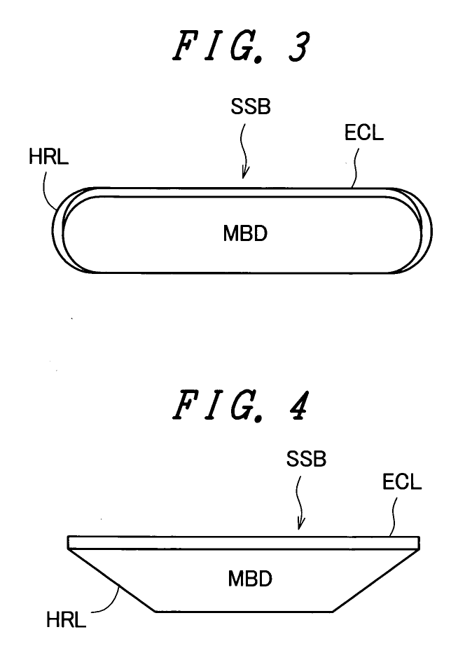

FIG. 3 is a cross-sectional view for explaining a modified example of a discharge preventing member SSB explained in FIG. 2. Further, FIG. 4 is a cross-sectional view for explaining another modified example of the discharge preventing member SSB explained in FIG. 2. The discharge preventing member SSB shown in FIG. 3 uses the insulating core member MBD having a shape of expanding the side surface outside thereof or a shape with rounded edges, provided with the conductive layer ECL on the upper surface, and a high-resistivity layer HRL formed on the side surface, and fixed to the scanning signal line in the lower surface thereof with the adhesive such as frit glass similarly to the case shown in FIG. 2.

The discharge preventing member SSB shown in FIG. 4 uses the insulating core member MBD having an inverted trapezoidal shape, provided with the conductive layer ECL on the upper surface, and is fixed to the scanning signal line in the lower surface thereof with the adhesive such as frit glass similarly to the case shown in FIG. 2. It should be noted that the high-resistivity layer HRL can also be formed on the side surface thereof.

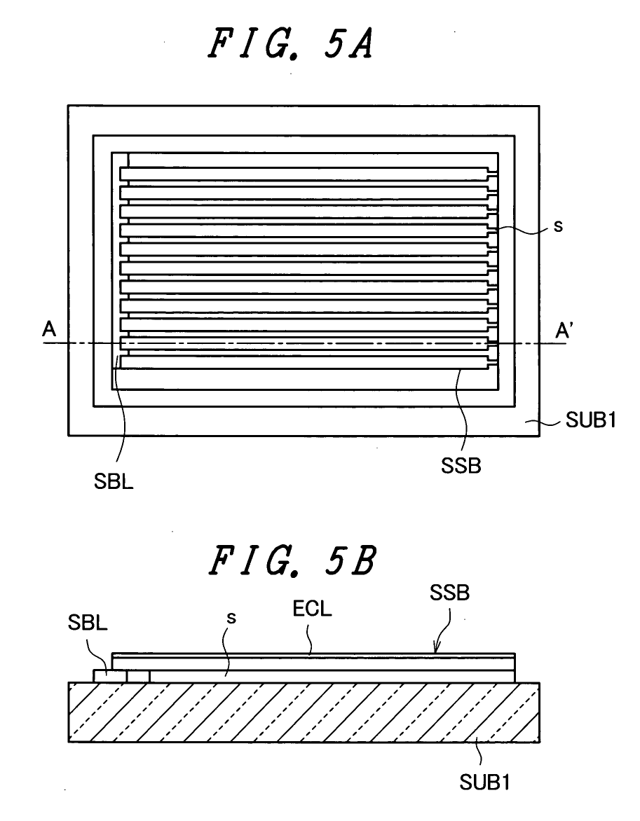

FIGS. 5A and 5B are an overall view of the rear panel for explaining the first embodiment of the present invention, wherein FIG. 5A is a plan view, and FIG. 5B is a cross-sectional view along the A-A′ line shown in FIG. 5A. The discharge preventing members SSB are fixed on the scanning signal lines s, and commonly connected to a discharge preventing member potential supply line SBL on one end of the display area. The discharge preventing member potential supply line SBL is connected to a grounding line or an arbitrary potential via an extraction line not shown.

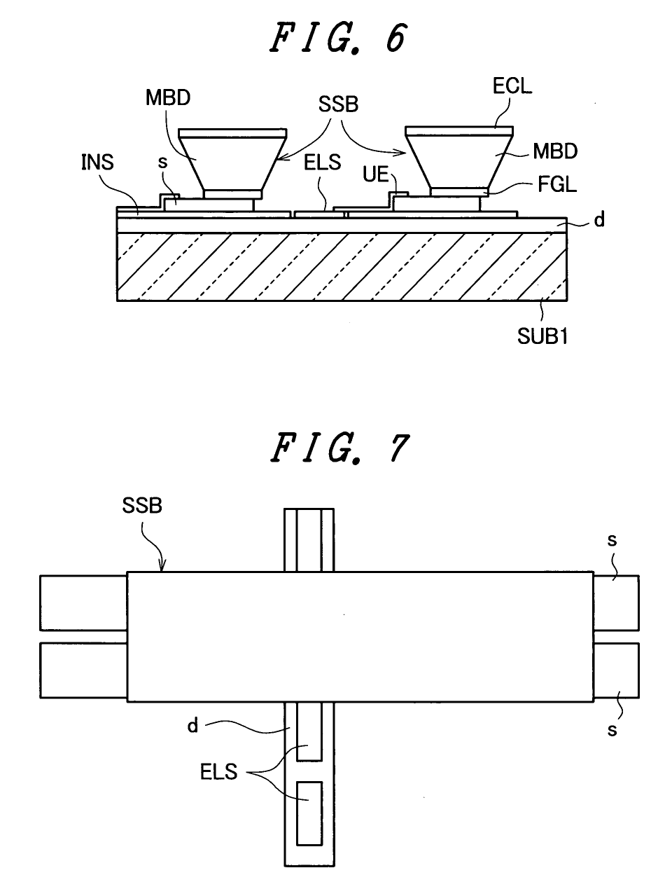

FIG. 6 is a cross-sectional view of the rear panel for explaining the configuration in the case in which the discharge preventing member is used for pixel separation. In the MIM type of thin film electron source, it is required to separate the upper electrode for every scanning signal line to realize pixel separation. In FIG. 6, the discharge preventing member SSB is fixed with the position shifted from the scanning signal line s by an offset towards the side of the adjacent pixel. The discharge preventing member SSB with an inverted trapezoidal cross-section shown in FIG. 4 is suitable for this usage.

After fixing the discharge preventing members SSB to the scanning signal lines s with the frit glass or the like, the conductive layers ECL are formed on the surfaces of the discharge preventing members SSB facing the anode by sputtering metal films. In this case, the upper electrodes UE for composing the electron sources are also formed simultaneously. With the offset in the discharge preventing members SSB, the upper electrodes UE of the electron sources composing the pixels selected by the adjacent scanning signal lines s are automatically separated by self-alignment.

FIG. 7 is a plan view of a substantial part for explaining the case in which the discharge preventing member is disposed straddling two scanning signal lines adjacent to each other. In the image display device of this case, the pixels to be selected are disposed on the opposite side of a pair of adjacent scanning signal lines s. Therefore, two pixels (electron sources ELS) formed on the data signal line d are disposed between the discharge preventing members SSB adjacent to each other.

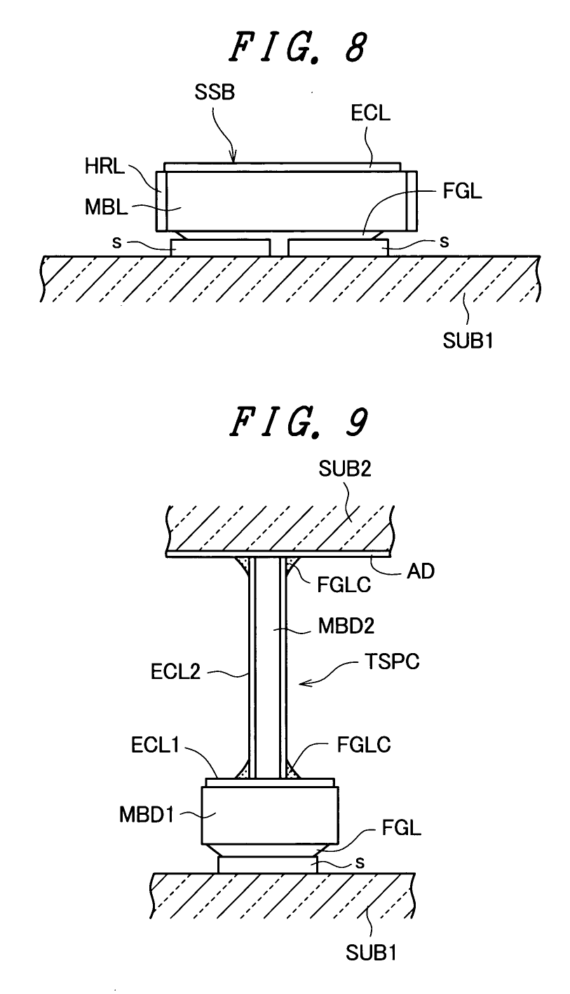

FIG. 8 is a cross-sectional view of the substantial part shown in FIG. 7 in which the discharge preventing member is disposed straddling the two scanning signal lines adjacent to each other. The discharge preventing member SSB used in FIG. 8 has a width larger than the width of the two scanning signal lines disposed adjacent to each other similarly to the case explained in FIG. 2. The discharge preventing member SSB is bonded on the two adjacent scanning signal lines s with the frit glass or the like.

### Second Embodiment

FIG. 9 is a cross-sectional view of a substantial part of a rear panel for explaining a second embodiment of the present invention. In the second embodiment, a distance maintaining member TSPC provided with a discharge preventing function is disposed on the scanning signal line s and between the front panel and the rear panel. The distance maintaining member TSPC in the second embodiment has an inverted T-shaped cross-section composed of a strip section and a wall-like section. The strip section is formed of a first insulating core member MBD1 made preferably of glass, and is provided with the conductive layer ECL1 on the upper surface (the surface facing the anode). Further, the wall-like section is formed of a second insulating core member MBD2 similarly made preferably of glass, and is provided with the conductive layer ECL2 formed on the side surface thereof. It should be noted that instead of the conductive layer ECL2, the insulating core member MBD2 itself can be provided with electrical conductivity.

The strip section and the wall-like section are integrated with a conductive adhesive FGLC to form the distance maintaining member TSPC having the inverted T-shaped cross-section and provided with the discharge preventing function. The distance maintaining member TSPC provided with the discharge preventing function is bonded on the scanning signal line s in the strip section with the adhesive FGL such as frit glass. It is preferable that the width of the strip section of the distance maintaining member TSPC is arranged to be greater than the width of the scanning signal line s, and the dimensions are arranged so that the strip section of the distance maintaining member TSPC covers the scanning signal line s when viewed from the anode. The upper end of the wall-like section of the distance maintaining member TSPC is bonded with the anode AD of the front substrate SUB2 with the conductive adhesive FGLC.

By arranging the surface resistance value of the conductive layer ECL1 of the strip section to be lower than the surface resistance value of the conductive layer ECL2 of the surface of the wall-like section, the charge on the surface of the wall-like section can immediately be discharged to the outside through the conductive layer ECL1 of the strip section.

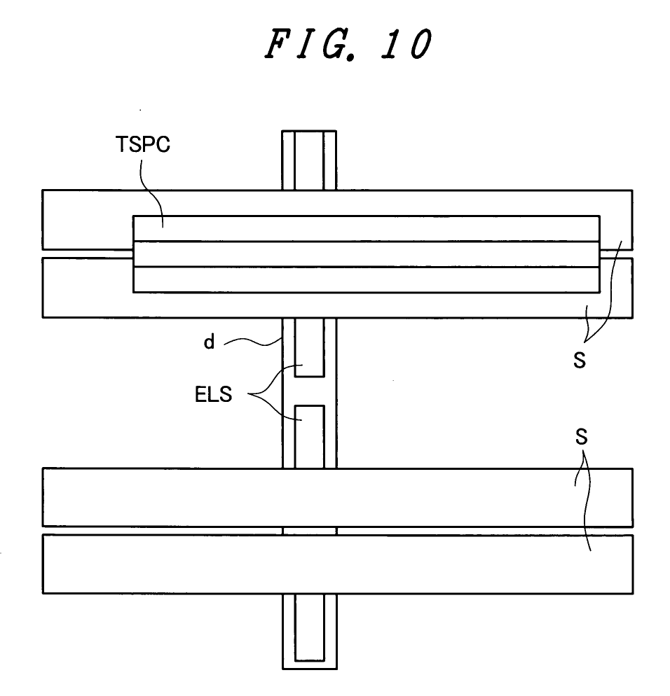

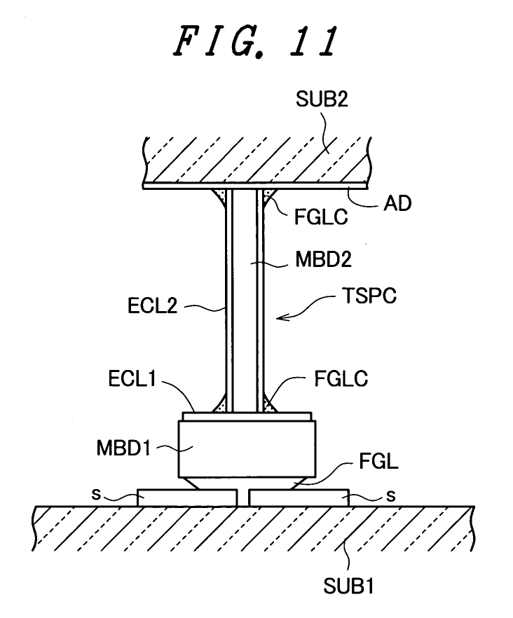

FIG. 10 is a plan view of a substantial part for explaining the case in which the distance maintaining member TSPC provided with the discharge preventing function shown in FIG. 9 is disposed straddling the two scanning signal lines adjacent to each other. Further, FIG. 11 is a cross-sectional view of a substantial part shown in FIG. 10. The configuration shown in FIGS. 10 and 11 is the same as shown in FIG. 7 except the point that the discharge preventing member is replaced with the distance maintaining member TSPC.

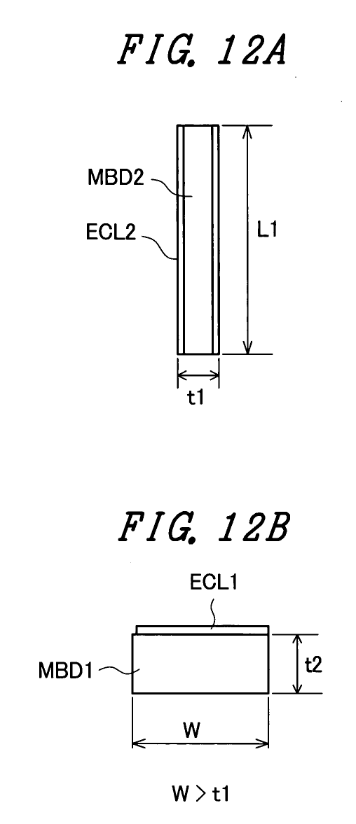

FIGS. 12A and 12B are diagrams for explaining an example of dimensions of the distance maintaining member TSPC provided with the discharge preventing function and having an inverted T-shaped cross-section. The height L1 of the wall-like section shown in FIG. 12A is in a range of 0.5 through 5 mm, and the thickness t1 thereof is in a range of 0.05 through 0.3 mm. The height t2 of the strip section shown in FIG. 12B is in a range of 0.05 through 0.3 mm, and the width W thereof is equal to or greater than the thickness t1 of the wall-like member. It should be noted that the distance maintaining member TSPC having the inverted T-shaped cross-section and provided with the discharge preventing function is not limited to have the configuration of joining the both strip section and the wall-like section provided as separated members as described above, but can also be formed as a single member.

### Third Embodiment

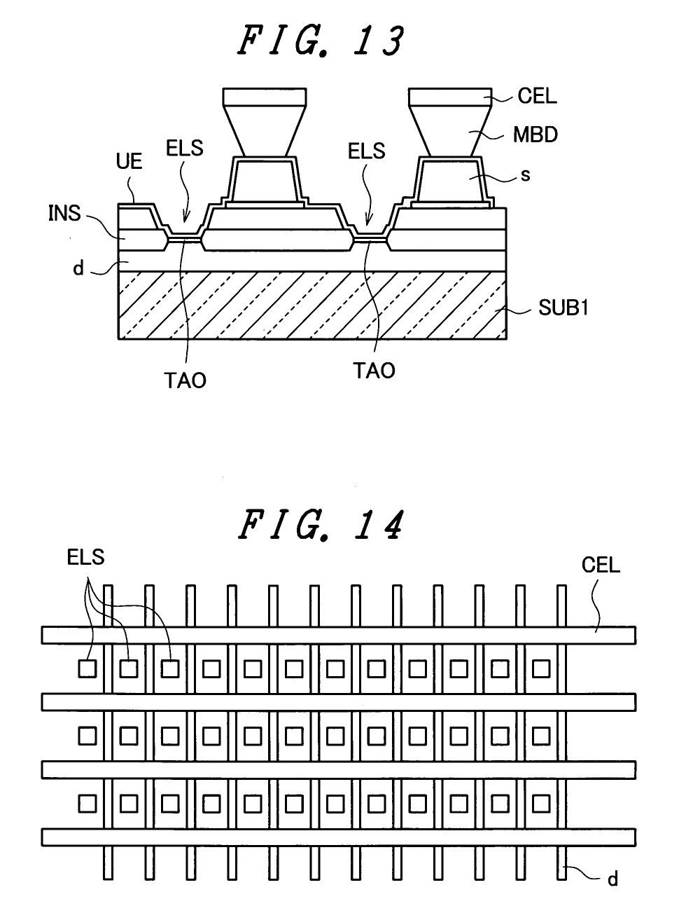

FIG. 13 is a cross-sectional view of a substantial part of a rear panel for explaining a third embodiment of the present invention. Further, FIG. 14 is a schematic plan view of the rear panel. In the third embodiment, discharge preventing members similar to the discharge preventing member shown in FIG. 4 and for suppressing the discharge between the anode and the electron sources are disposed on the scanning signal lines s. Further, the discharge preventing member is disposed on each of the scanning signal lines, and the conductive layer disposed on the surface of the discharge preventing member facing the anode is used as a convergence electrode CEL.

A pair of convergence electrodes CEL located across the electron source ELS is provided with a potential more positive than the potential of the electron source ELS. Thus, a convergence electric field providing the electron emitted towards the anode with the quadrupole operation is generated, expansion of the electron flux passing therethrough is suppressed, thereby improving a margin for preventing landing a different color area in the arrangement direction (horizontal direction) of the three color fluorescent materials R, G, and B on the fluorescent surface, and improving the color purity.

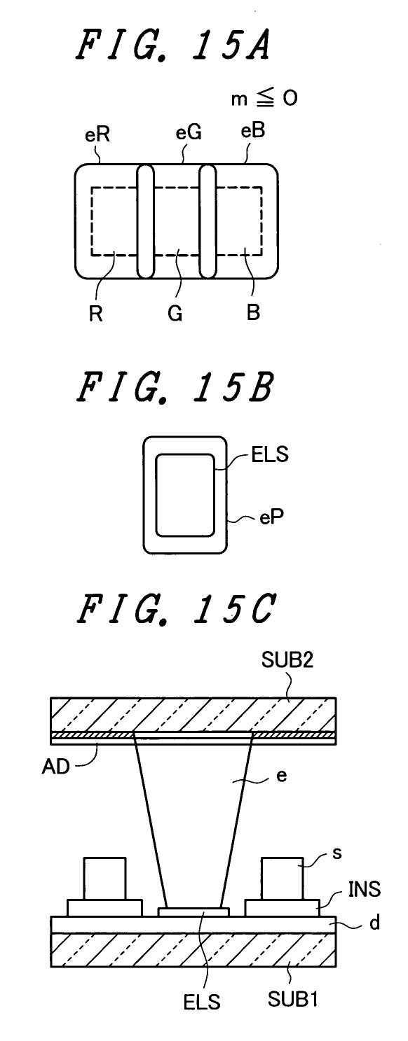

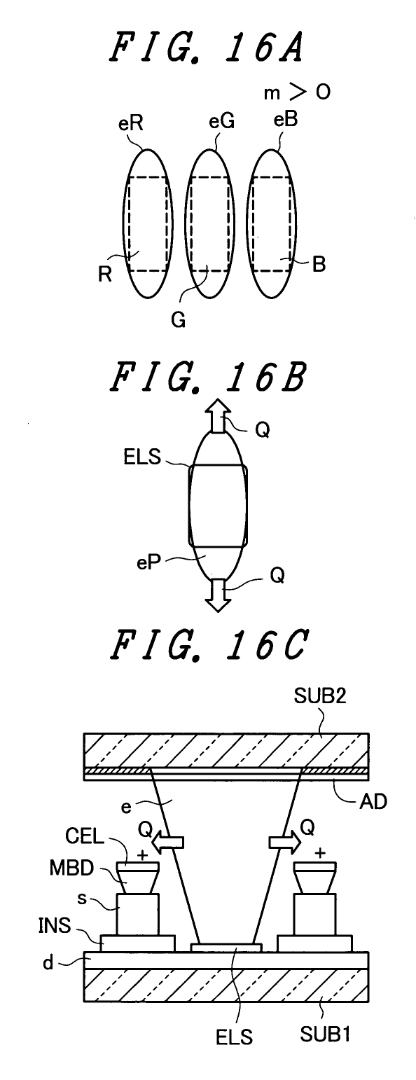

FIGS. 15A, 15B, and 15C are diagrams for explaining advantages of the image display device having a configuration without the convergence electrodes CEL, and FIGS. 16A, 16B, and 16C are diagrams for explaining advantages of the image display device having the configuration of the third embodiment of the present invention provided with the convergence electrodes CEL.

Regarding the image display device having a configuration without the convergence electrodes CEL, the shape and the size of the electron source and the profile of the electron flux emitted towards the anode are as shown in FIG. 15B. As shown in FIGS. 15A and 15C, in the case in which the discharge preventing members having the convergence electrodes CEL are not disposed on the scanning signal lines s, the spots eR, eG, and eB of the electron fluxes landing the three color fluorescent materials R, G, and B on the fluorescent surface have margins m for preventing landing a different color area are no greater than zero (m≦0).

In contrast, as shown in FIGS. 16A and 16C, in the case of the third embodiment in which the discharge preventing members having the convergence electrodes CEL are disposed on the scanning signal lines s, the electron flux passing by the convergence electrodes CEL is elongated on the sides of the pair of scanning signal lines s side (in the vertical direction) as illustrated with the arrows Q by the quadrupole operation to form a profile compressed in a direction (a horizontal direction) along which the scanning signal lines extend. In other words, the electron fluxes are modified to have vertically long shapes. As a result, the spots eR, eG, and eB of the electron fluxes landing the three color fluorescent materials R, G, and B on the fluorescent surface have margins m for preventing landing a different color area exceed zero (m>0). Therefore, the margin for preventing landing a different color area in the direction (the arranging direction of the three colors of fluorescent materials R, G, and B) along which the scanning signal lines extend on the fluorescent surface is improved, and thus the color purity can be improved. Further, by forming the fluorescent materials R, G, and B on the fluorescent surface to have vertically long dot shapes or a stripe structure, the use efficiency of the vertically long electron beam on the fluorescent surface is improved, thus making a contribution to increase in the light emission intensity.

### Fourth Embodiment

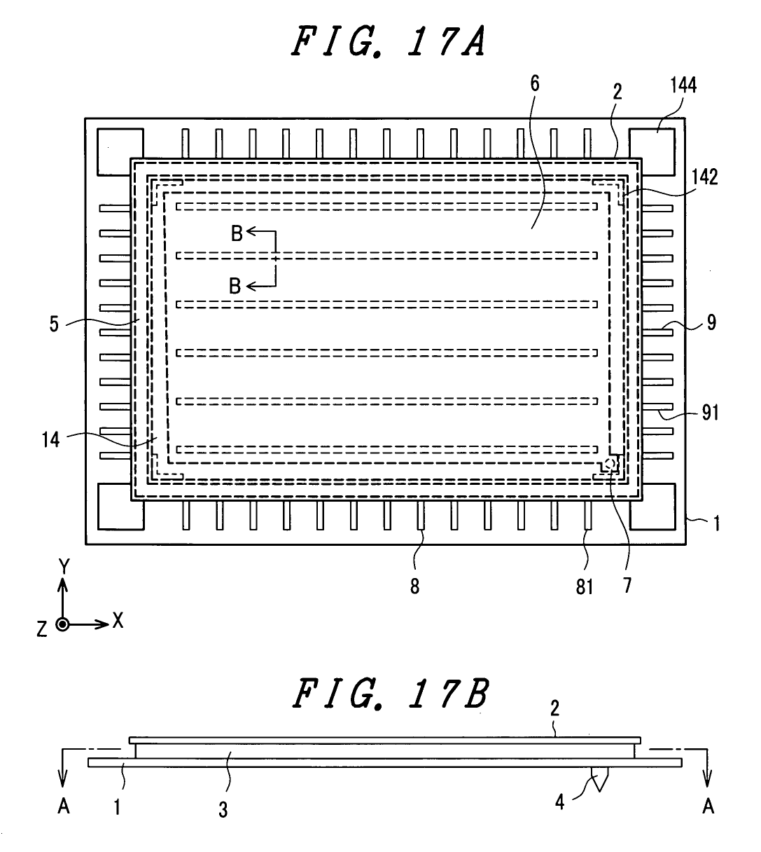

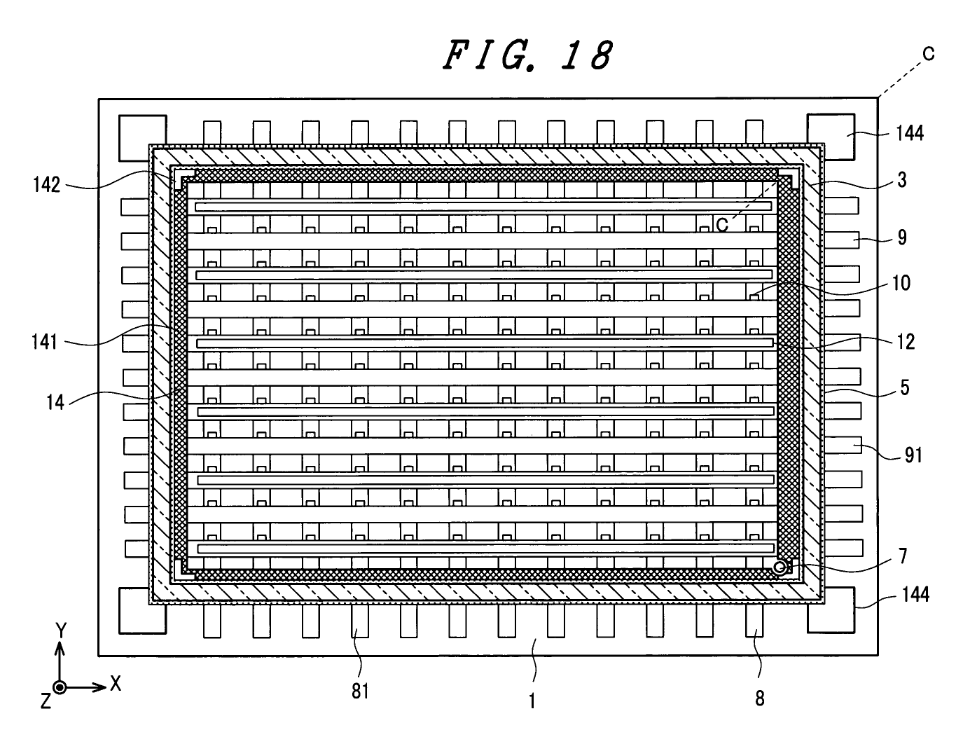

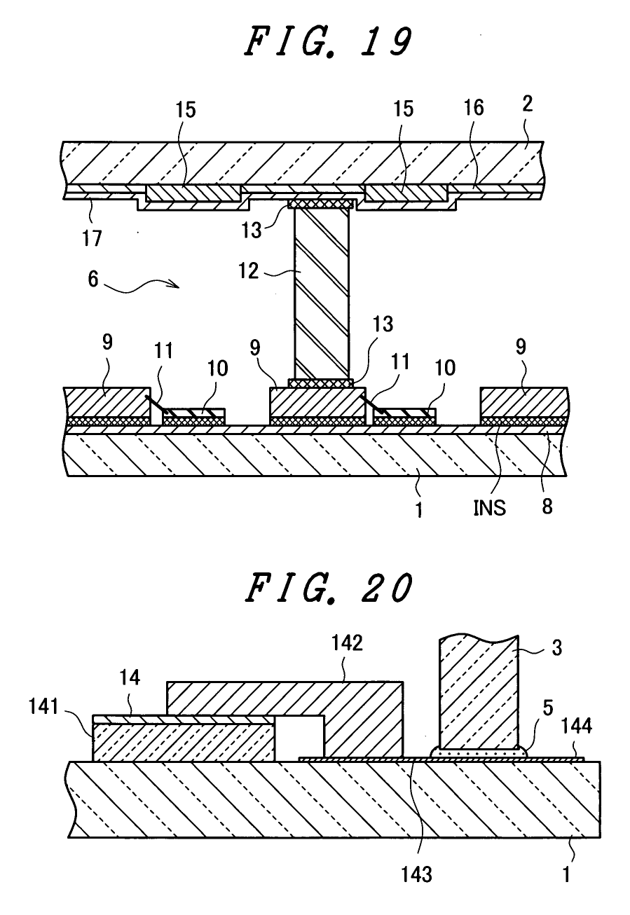

FIGS. 17A, 17B, and 18 through 20 are schematic diagrams for explaining a fourth embodiment of the image display device according to the present invention, wherein FIG. 17A is a plan view from the side of the front substrate, FIG. 17B is a side view of FIG. 17A, FIG. 18 is a plan view along the A-A line shown in FIG. 17B, FIG. 19 is a cross-sectional view along the B-B line shown in FIG. 17A, and FIG. 20 is a cross-sectional view along the C-C line shown in FIG. 18.

In the FIGS. 17A, 17B, and 18 through 20, the reference numeral 1 denotes the rear substrate, the reference numeral 2 denotes the front substrate, the reference numeral 3 denotes the frame member, the reference numeral 4 denotes an evacuation tube, the reference numeral 5 denotes seal member, the reference numeral 6 denotes a display area, the reference numeral 7 denotes a through hole, the reference numeral 8 denotes the data signal lines, the reference numeral 9 denotes the scanning signal lines, the reference numeral 10 denotes the electron sources, the reference numeral 11 denotes connection electrodes, the reference numeral 12 denotes the spacers, the reference numeral 13 denotes adhesive members, the reference numeral 14 denotes a protective electrode, the reference numeral 15 denotes the fluorescent layer, the reference numeral 16 denotes a light blocking black matrix (BM) film, and the reference numeral 17 denotes a metal back (an acceleration electrode) composed of the metal thin film.

The both substrates 1, 2 are each formed of a glass plate with the thickness of a few millimeters, for example, about 1 through 10 mm, has a substantially rectangular shape, and both are disposed with a predetermined distance from each other. The reference numeral 3 denotes the frame member having a frame shape, and the frame member 3 is formed, for example, of a sintered body of the frit glass or a glass plate, shaped as a substantial rectangle by itself or a combination of a plurality of members, and intervenes between the both substrates 1, 2.

The frame member 3 intervenes on the peripheries of and between the both substrates 1, 2, and the both end surfaces of the frame member 3 are bonded airtight with the both substrates 1, 2. The thickness of the frame member 3 is in a range of several millimeters through several tens of millimeters, and the height thereof is arranged to be substantially the same size as the distance between the both substrates 1, 2. The reference numeral 4 denotes the evacuation tube, and the evacuation tube 4 is fixed to the rear substrate 1. The reference numeral 5 denotes the seal member, and the seal member 5 is composed, for example, of the frit glass, and joins the frame member 3 and the both substrates 1, 2 to seal airtight.

The space including the display area 6 and surrounded by the frame member 3, the both substrates 1, 2, and the seal member 5 is evacuated via the evacuation tube 4, and is kept vacuum with the degree of vacuum of, for example, 10⁻⁵ through 10⁻⁷ Torr. Further, the evacuation tube 4 is attached to the outside surface of the rear substrate 1 as described above, connected to the through hole 7 provided so as to penetrate the rear substrate 1, and sealed after the evacuation is completed.

The reference numeral 8 denotes the data signal lines, and the data signal lines 8 are disposed on the inside surface of the rear substrate 1 extending in one direction (the Y direction) and arranged in parallel in another direction (the X direction) using a metal material described below. The data signal lines 8 extends from the space including the display area 6 to an end surface of the rear substrate 1 passing airtight through the sealing area between the frame member 3 and the rear substrate 1. The outer end portion of each of the data signal lines 8 from the sealing area is defined as a data signal line extraction terminal 81.

The reference numeral 9 denotes the scanning signal lines, and the scanning signal lines 9 are disposed above the data signal lines 8 extending in the another direction (the X direction) traversing the data signal lines 8, and arranged in parallel in the one direction (the Y direction) using a metal material described below. The scanning signal lines 9 extend from the space including the display area 6 to the vicinity of the end surface of the rear substrate 1 passing airtight through the sealing area between the frame member 3 and the rear substrate 1. The outer end portion of each of the scanning signal lines 9 from the sealing area is defined as a scanning signal line extraction terminal 91.

The reference numeral 10 denotes the MIM electron source, for example, a kind of electron source disclosed in JP-A-2004-363075, and the electron source 10 is disposed in the vicinity of each of the intersections between the scanning signal lines 9 and the data signal lines 8. Further, the electron source 10 is connected to the scanning signal line 9 via a connection electrode 11. Still further, an interlayer insulating film INS is disposed between the data signal lines 8 and the scanning signal lines 9.

In this case, as the data signal lines 8, for example, an aluminum (Al) film is used, and as the scanning signal lines 9, for example, a (Cr/Al/Cr) film obtained by putting aluminum (Al) between chromium (Cr) layers or a (Cr/Cu/Cr) film obtained by putting copper (Cu) between chromium (Cr) layers is used. Further, although the line extraction terminals 81, 91 are provided on the both ends of the signal lines, they can be provided on either one of the ends.

Then, the reference numeral 12 denotes the spacers, and the spacers 12 are each formed of a plate-like member made of an insulating material such as glass or ceramics or of a member with some conductivity, and generally disposed for a plurality of pixels at positions where the operations of the pixels are not disturbed. The spacers 12 have specific resistances of about 10⁸ through 10⁹ Ωcm, and a configuration with little unevenness in distribution of the resistance value as a whole. Further, in the example shown in FIG. 18, the spacers 12 are disposed upright alternately on the scanning signal lines 9 substantially in parallel to the frame member 3, and fixedly bonded with the both substrates 1, 2 with the adhesive members 13. Still further, the spacers 12 can be fixedly bonded with the substrates only on one end, and regarding the arrangement thereof, each of the spacers 12 is disposed for a plurality of pixels at positions where the operations of the pixels are not disturbed. Further, the spacers 12 can be disposed on the scanning signal line 9 while being divided into several pieces.

Although the dimensions of the spacers 12 are determined in accordance with the dimensions of the substrates, the height of the frame member, the materials of the substrates, the distance between the spacers, the material of the spacers, in general, the height is substantially the same as the size of the frame member described above, the thickness is in a range of several tens of micrometers through several millimeters. The length of the spacer is in a range of about 20 mm through 1000 mm, or a longer size is also possible. Preferably, the range of about 80 mm through 300 mm will be practicable.

The reference numeral 14 denotes the protective electrode, and the protective electrode 14 is made of silver (Ag) material, and disposed adjacent to the inside of the entire frame member 3 so as to cover a part of the both signal lines 8, 9 via an insulating layer 141 formed of a glass plate. The glass plate with a thickness of 0.3 mm and a width of 3 mm is used for forming the insulating layer 141, and the thickness of the protective electrode 14 is set to be 20 μm.

The protective electrode 14 is connected to feed terminals 142 disposed on the corners, and is further connected to one end of a protective electrode line 143 via the feed terminals 142, thus the protective electrode 14 is kept at a predetermined potential such as the ground potential. The feed terminals 142 has a role of fixing the protective electrode 14 in addition to the role of electrical connection described above.

On the other hand, the other end of the protective electrode line 143 passes airtight through the sealing area between the frame member 3 and the rear substrate 1, and is connected to the protective electrode line extraction terminal 144 provided in a gap between the both signal line extraction terminals 81, 91.

As the protective electrode 14, besides Ag described above, the metal material with little gas emission such as gold (Au) or nickel (Ni) can be used, and further, as the insulating layer 141, in addition to the glass plate described above, the insulating material such as a ceramics plate or frit glass used as the seal member 5 can also be used.

Further, the feed terminals 142, in the fourth embodiment, is formed of a metal material (42% Ni, 6% Cr, 52% Fe) having a similar thermal expansion coefficient to glass, and is used while fixed to the rear substrate 1.

On the other hand, on the inside surface of the front substrate 2 to which one end of each of the spacers 12 is fixed, there are disposed fluorescent layers 15 for red, green, or blue in windows partitioned by a light blocking black matrix (BM) film 16, and further, the metal back (an acceleration electrode) 17 formed of a metal thin film is disposed so as to cover these components using, for example, an evaporation method, thereby forming the fluorescent surface. In the operation conditions, an anode voltage of about 3 kV through 20 kV is applied to the fluorescent surface. The metal back 17 is a light reflection film for reflecting the light emitted towards the opposite side of the front substrate 2, namely towards the side of the rear substrate 1 and emitting it towards the front substrate 2, and for improving the extracting efficiency of the emitting light and at the same time has a function of preventing the charge on the surface of the fluorescent particles.

As the fluorescent material, for example, Y₂O₃:Eu or Y₂O₂S:Eu for red, ZnS:Cu, Al or Y₂SiO₅:Tb for green, and ZnS:Ag, Cl or ZnS:Ag, Al for blue can be used. The fluorescent layer 15 includes the fluorescent particles with average particle size of, for example, about 4 μm through 9 μm, and has a thickness of, for example, about 10 μm through 20 μm.

### Fifth Embodiment

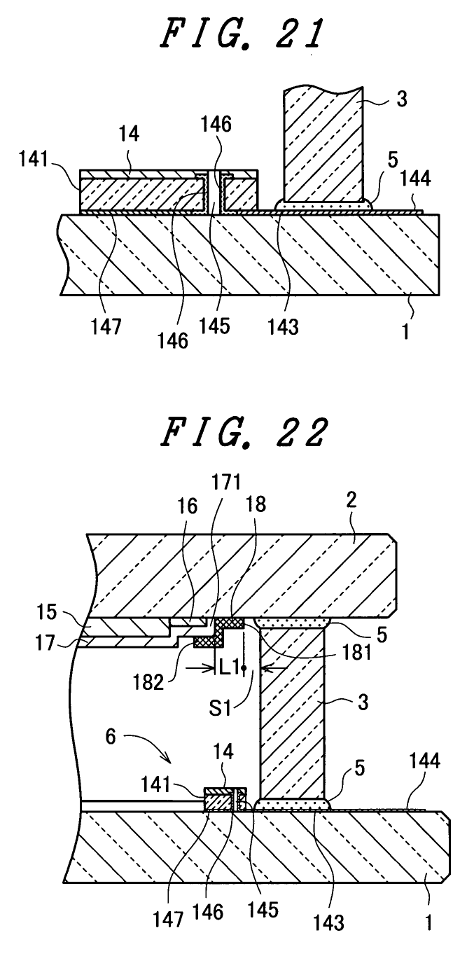

Then, FIG. 21 is a schematic cross-sectional view corresponding to FIG. 20 described above, and for explaining a fifth embodiment of an image display device according to the present invention, in which the same parts as in the drawings described above are denoted with the same reference numerals.

In FIG. 21, the protective electrode 14 is disposed on the insulating layer 141, and is electrically connected to the protective electrode line 143 via a metal layer 146 provided to a through hole 145 penetrating the insulating layer 141.

Further, the insulating layer 141 covers the signal lines not shown, and is fixed to the rear substrate 1 via a fixing member 147 such as frit glass.

According to the configuration of the fifth embodiment, since the structure of fixing the insulating layer 141 to the rear substrate 1 via the fixing member 147 is adopted, the feed terminals 142 described above can be eliminated, thus reduction of the number of components and reduction of manpower can be realized.

### Sixth Embodiment

Then, FIG. 22 is a schematic cross-sectional view for explaining a sixth embodiment of an image display device according to the present invention, in which the same parts as in the drawings described above are denoted with the same reference numerals.

In FIG. 22, the configuration of the side of the rear substrate 1 has the same specification as the fifth embodiment described above, and the side of the fluorescent surface of the front substrate 2 is provided with a high-resistivity film 18.

The high-resistivity film denoted with the reference numeral 18 covers entire circumference of the edge 171 of the metal back 17, and extends towards the frame member 3 with the edge 181 thereof disposed at a predetermined distance S1 from the frame member 3 in a contactless manner. On the other hand, a leading edge 182 of the high-resistivity film 18 is disposed overlapping to cover the entire circumference of the edge 171 of the metal back 17 as described above, and functions as a high voltage relaxation layer.

Although the high-resistivity film 18 covers the edge 171 of the metal back 17 and extends towards the frame member 3, the length L1 from the edge 171 of the metal back 17 to the edge 181 of the high-resistivity film 18 is required to be in a range of about 3 mm through 10 mm. If it is shorter than 3 mm, the high voltage relaxation effect can hardly be expected, and if it exceeds 10 mm, the display area becomes too small and the peripheral area becomes too large. Therefore, it is preferably in a range of about 4 mm through 8 mm. Further, the film thickness of 3 μm through 20 μm is necessary, and of 5 μm through 10 μm is particularly preferable. If the thickness is smaller than 3 μm, the film might disappear, and if it exceeds 20 μm, the high-voltage relaxation effect can hardly be expected.

The high-resistivity film 18 is composed of an insulating high-resistivity oxide such as iron oxide or chromium oxide and an inorganic binder such as water glass. As the iron oxide, for example, Fe₂O₃ having a good track record in use for cathode-ray tubes, and as the chromium oxide, for example, Cr₂O₃ are respectively recommended. In the present configuration, the iron oxide or the chromium oxide with particle size of 0.1 μm through 10 μm is used. In particular, if it exceeds 10 μm, a small problem might be caused in the voltage relaxation effect, and accordingly, 0.5 μm through 3 μm is preferable.

In the case in which the water glass similarly having a good track record in use for cathode-ray tubes is used as the inorganic binder of the high-resistivity film 18, the water glass has a concentration of 1 weight percent through 20 weight percent, and preferably 3 weight percent through 10 weight percent. Further, in the combination of the water glass and the Fe₂O₃, the mixture ratio of water glass vs Fe₂O₃ is preferably in a range of 1:4 through 1:10, and in the combination of the water glass and the Cr₂O₃, the mixture ratio of water glass vs Cr₂O₃ is preferably in a range of 1:4 through 1:10.

The high-resistivity film 18 is formed by applying the mixed solution of the materials described above on the appropriate region with a known tool such as a sponge, a brush or a paintbrush, and then drying to complete. The resistance value after completion is in a range of 10⁹ Ω/sq. through 10¹³ Ω/sq. and there can be obtained the high-resistivity film with the resistance value dramatically different from the resistance value lower than 10² Ω/sq. of the fluorescent surface provided with the metal back 17.

In the sixth embodiment, by disposing the high-resistivity film 18 described above, the high voltage relaxation is performed, the electric field around the edge 171 of the metal back 17 is smoothed, as a result, the number of times of occurrence of discharge is dramatically reduced, and in cooperation with the effect of the protective electrode 14, a long-lived image display device superior in display quality can be obtained.

### Seventh Embodiment

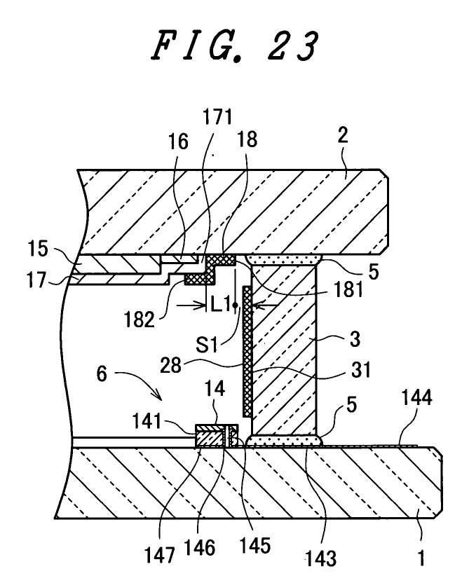

FIG. 23 is a schematic cross-sectional view showing a seventh embodiment of an image display device according to the present invention, which corresponds to FIG. 22, and the same sections as in the drawings described above are denoted with the same reference numerals.

In FIG. 23, the reference numeral 28 denotes a high-resistivity film, and the high-resistive film 28 is disposed on the inside surface 31 throughout the entire circumference of the frame member 3 in a contactless manner with the both substrates 1, 2. The high-resistivity film 28 is formed of a material having the same composition as that of the high-resistivity film 18 disposed on the side of the fluorescent surface. The film thickness thereof is also set within the similar sizes as in the sixth embodiment.

In the seventh embodiment, by disposing the second high-resistivity film 28 on the inside surface 31 of the frame member 3 throughout the entire circumference of the frame member 3 in addition to the high-resistivity film 18 disposed on the side of the fluorescent surface, the high voltage relaxation is performed, inclination in the equipotential lines around the edge 171 of the metal back 17 is further smoothed, as a result, the number of times of occurrence of discharge is dramatically reduced, and in cooperation with the effect of the protective electrode 14, a long-lived image display device superior in display quality can be obtained.

Although in the embodiments described above, the structure using the MIM type as the electron source is exemplified, the present invention is not limited to such a structure, but can also be applied to the light emitting FPD using various kinds of electron sources as described above.

Further, although in the embodiments described above, the structure in which the metal back (the acceleration electrode) is formed so as to cover the entire surface of the black matrix film provided with the fluorescent layers is shown as the anode. However, the present invention is not limited to this structure, by adopting the anode structure in which the metal back (the acceleration electrode) is divided into a number of strips corresponding to the horizontal arrangement of the fluorescent pixels, the breakage of the electron source and the wiring by the discharge phenomenon can also be suppressed similarly to the embodiments described above. Since the charge storage capacity of each of the number of divided metal backs itself becomes smaller, when the spark is caused in the actual operation, the amount of charge flowing in the electron sources and the wiring can be reduced. By combining the anode dividing structure with each of the embodiments described above, the discharge prevention effect becomes more remarkable, thus the image display device superior in reliability can be provided.

What is claimed is:

1. An image display device comprising:
a plurality of scanning signal lines;
a plurality of data signal lines traversing the scanning signal lines;
a rear panel composed mainly of a rear substrate having a plurality of electron sources arranged adjacent to intersections between the scanning signal lines and the data signal lines inside a display area on an inside surface of the rear substrate;
a front panel composed mainly of a front substrate having a plurality of fluorescent layers arranged corresponding to the electron sources and an anode, to which a high voltage is applied with respect to the electron sources, on the inside surface of the front substrate; and
a plurality of distance maintaining members disposed between the front panel and the rear panel, a space between the front panel and the rear panel being sealed airtight,
wherein a discharge preventing member disposed on the scanning signal line for suppressing discharge between the anode and the electron source is provided.

2. The image display device according to claim 1, wherein
the discharge preventing member each has a strip shape along the scanning signal line.

3. The image display device according to claim 2, wherein
the strip-shaped discharge preventing member is each provided with a conductive layer on a surface facing the anode.

4. The image display device according to claim 3, wherein
a side edge of each of the at least one strip-shaped discharge preventing member adjacent to the electron source is positioned back to the inside of the discharge preventing member from a position of a side edge of the discharge preventing member adjacent to the anode.

5. The image display device according to claim 2, wherein
the discharge preventing member is each disposed straddling two of the scanning signal lines adjacent to each other.

6. The image display device according to claim 3, wherein
the conductive layer of each of the plurality of discharge preventing members is commonly connected to a predetermined potential outside the display area.

7. An image display device comprising:
a plurality of scanning signal lines;
a plurality of data signal lines traversing the scanning signal lines;
a rear panel composed mainly of a rear substrate having a plurality of electron sources arranged between the scanning signal lines inside a display area on an inside surface of the rear substrate;
a front panel composed mainly of a front substrate having a plurality of fluorescent layers arranged corresponding to the electron sources and an anode, to which a high voltage is applied with respect to the electron sources, on the inside surface of the front substrate, a space between the front panel and the rear panel being sealed airtight; and
a convergence electrode disposed on the scanning signal line and for providing an electron emitted towards the anode with a quadrupole operation.

8. An image display device comprising:
a plurality of scanning signal lines;
a plurality of data signal lines traversing the scanning signal lines;
a rear panel composed mainly of a rear substrate having
a plurality of electron sources arranged adjacent to intersections between the scanning signal lines and the data signal lines inside a display area on an inside surface of the rear substrate;
a front panel composed mainly of a front substrate having a plurality of fluorescent layers arranged corresponding to the electron sources and an anode, to which a high voltage is applied with respect to the electron sources, on the inside surface of the front substrate; and
a plurality of distance maintaining members disposed on the scanning signal lines between the front panel and the rear panel,
a space between the front panel and the rear panel being sealed airtight, and
the distance maintaining members each having an inverted T-shaped cross-section composed of a strip section and a wall-like section.

9. The image display device according to claim 8, wherein
each of a surface of the strip section facing the anode and a surface of the wall-like section is provided with a conductive layer.

10. The image display device according to claim 9, wherein
a surface resistance value of the conductive layer of the strip section is lower than a surface resistance value of the conductive layer of the surface of the wall-like section.

11. The image display device according to claim 8, wherein
the distance maintaining members are each disposed straddling two of the scanning signal lines adjacent to each other.

12. The image display device according to claim 9, wherein
the conductive layer provided on the surface of the wall-like section of each of the plurality of distance maintaining members is commonly connected to a predetermined potential outside the display area.

13. The image display device according to claim 8, wherein
each of the strip section and the wall-like section of each of the distance maintaining members is formed by joining separated members.

14. The image display device according to claim 8, wherein
the strip section and the wall-like section of each of the distance maintaining members are parts of a single member.

15. An image display device comprising:
a rear substrate including
a plurality of scanning signal lines extending in one direction and disposed in parallel in another direction perpendicular to the one direction,
a plurality of data signal lines extending in the another direction and disposed in parallel in the one direction so as to traverse the scanning signal lines,
an interlayer insulating film disposed between the data signal lines and the scanning signal lines, and
a plurality of electron sources respectively disposed adjacent to intersections between the scanning signal lines and the data signal lines;
a front substrate facing the rear substrate with a predetermined distance and having a fluorescent film including fluorescent layers disposed corresponding to the electron sources, and an acceleration electrode for accelerating electrons emitted from the electron sources so as to direct the electrons towards the fluorescent layers;
a frame member intervening between the rear substrate and the front substrate so as to surround a display area and for maintaining a predetermined distance;
a seal member for bonding the frame member with the front substrate and the frame member with the rear substrate, respectively, in sealing areas to seal an inside space; and
a protective electrode disposed adjacent to an inside surface of the frame member via an insulating layer covering a part of the signal lines and kept at a potential lower than a potential of the acceleration electrode.

16. The image display device according to claim 15, wherein
the protective electrode is kept at a ground potential.

17. The image display device according to claim 15, wherein
the protective electrode has a configuration of providing a conductive film on an insulating glass plate.

18. The image display device according to claim 15, wherein
an extraction line connected to the protective electrode is separately provided from an extraction line connected to the signal line.

19. The image display device according to claim 15, wherein
a high-resistivity film extending to cover an edge of the fluorescent film along the frame member and disposed at a predetermined distance from the frame member is provided.

20. The image display device according to claim 19, wherein
the high-resistivity film is further disposed in a region on the inside surface of the frame member and apart from both the rear substrate and the front substrate.

21. The image display device according to claim 19, wherein
the high-resistivity film has a resistance value in a range of 10⁹ Ω/sq. through 10¹³ Ω/sq.

22. The image display device according to claim 19, wherein
the high-resistivity film includes an insulating high-resistivity oxide.
